(19) United States
(12) Patent Application Publication
(10) Pub. No.: US 2020/0285434 A1
(43) Pub. Date: Sep. 10, 2020

(54) APPARATUS SETUP SYSTEM, APPARATUS SETUP METHOD, AND ELECTRONIC APPARATUS

(71) Applicant: KYOCERA DOCUMENT SOLUTIONS INC., OSAKA (JP)

(72) Inventors: HIROSHI NAKAMURA, OSAKA (JP); SATOSHI IMAI, OSAKA (JP); AYA KAMAKURA, OSAKA (JP); HIROSHI YOSHIMOTO, OSAKA (JP)

(21) Appl. No.: 16/804,296

(22) Filed: Feb. 28, 2020

(30) Foreign Application Priority Data
Mar. 5, 2019 (JP) 2019-039661

(51) Int. Cl. G06F 3/12; G06F 21/10

(52) U.S. Cl. CPC G06F 3/1231; G06F 2221/0753; G06F 21/105; G06F 3/1203

(57) ABSTRACT

An apparatus setup system includes: a first electronic apparatus; and a second electronic apparatus, the first electronic apparatus including a first controller module configured to generate a package file where an export instruction is input, the export instruction instructing to export an application, the package file at least including the application identifier and an electronic apparatus identifier of one different electronic apparatus, the second electronic apparatus including a second controller module configured to where the package file is input, check the electronic apparatus identifier included in the input package file against the electronic apparatus identifier stored in the second storage device, and where it is determined that the electronic apparatus identifier included in the input package file matches the electronic apparatus identifier stored in the second storage device, activate the application identified by the application identifier included in the package file.

### CROSS-REFERENCE TO RELATED PATENT APPLICATION

This application claims the benefit of Japanese Priority Patent Application JP 2019-039661 filed Mar. 5, 2019, the entire contents of which are incorporated herein by reference.

### FIELD OF THE DISCLOSURE

The present disclosure relates to an apparatus setup system. The present disclosure further relates to an apparatus setup method using the apparatus setup system. The present disclosure further relates to an electronic apparatus included in the apparatus setup system.

### BACKGROUND OF THE DISCLOSURE

Typically, when an electronic apparatus (for example, device such as image forming apparatus) is replaced, a license is transferred from an old electronic apparatus to a new electronic apparatus.

In a known technical field of electronic apparatuses, an application software (application program. Hereinafter referred to as “application”) operates in the upper stage of basic software (including operating system and middleware. Hereinafter referred to as “platform”.) for operating an electronic apparatus. Further, an E-license key (hereinafter referred to as activation key) issued for license of an application is known.

### SUMMARY OF THE DISCLOSURE

It is desirable to reduce a downtime without an activation key when an electronic apparatus is replaced, where the electronic apparatus has an application that requires an activation key for activation.

According to an embodiment of the present disclosure, there is provided an apparatus setup system, including:

a first electronic apparatus; and

a second electronic apparatus,

the first electronic apparatus including
a first storage device that stores an application and an application identifier unique to the application, and
a first controller module configured to generate a package file where an export instruction is input, the export instruction instructing to export an application, the package file at least including the application identifier and an electronic apparatus identifier of one different electronic apparatus,

the second electronic apparatus including
a second storage device that stores an electronic apparatus identifier identifying the second electronic apparatus from a different electronic apparatus, and
a second controller module configured to
   where the package file is input, check the electronic apparatus identifier included in the input package file against the electronic apparatus identifier stored in the second storage device, and
   where it is determined that the electronic apparatus identifier included in the input package file matches the electronic apparatus identifier stored in the second storage device, activate the application identified by the application identifier included in the package file.

According to an embodiment of the present disclosure, there is provided an apparatus setup method of setting up a second electronic apparatus executable by an apparatus setup system, the apparatus setup system including a first electronic apparatus and the second electronic apparatus, the first electronic apparatus including a first input module and a first controller module, the second electronic apparatus including a second input module and a second controller module, the apparatus setup method including:

inputting, by the first input module, an export instruction in the first controller module, the export instruction instructing to export an application;

outputting, by the first controller module, a package file where the export instruction is input, the package file at least including an electronic apparatus identifier of the second electronic apparatus and an application identifier unique to the application;

inputting, by the second input module, the package file in the second controller module;

where the package file is input, checking, by the second controller module, the electronic apparatus identifier of the second electronic apparatus included in the input package file against an electronic apparatus identifier stored in the second electronic apparatus; and

where it is determined that the electronic apparatus identifier of the second electronic apparatus included in the input package file matches the electronic apparatus identifier stored in the second electronic apparatus, activating, by the second controller module, the application identified by the application identifier included in the package file.

According to an embodiment of the present disclosure, there is provided an electronic apparatus, including:

a storage device;

an input module; and

a controller module,

the storage device storing
an application,
an application identifier unique to the application, and
an electronic apparatus identifier identifying the electronic apparatus from a different electronic apparatus,

the input module being configured to input an export instruction and a package file in the electronic apparatus, the export instruction instructing to export the application, the package file being used to import the application,

the controller module being configured to
generate the package file where the export instruction is input, the package file at least including the application identifier and the electronic apparatus identifier of one different electronic apparatus,
where the package file is input, check the electronic apparatus identifier included in the input package file against the electronic apparatus identifier stored in the storage device, and
where it is determined that the electronic apparatus identifier included in the input package file matches the electronic apparatus identifier stored in the storage device, activate the application identified by the application identifier included in the package file.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 shows an apparatus setup system according to an embodiment of the present disclosure;

FIG. 2 shows a hardware configuration of a first electronic apparatus;

FIG. 3 shows a hardware configuration of a second electronic apparatus;

FIG. 4 shows a functional configuration of the first electronic apparatus;

FIG. 5 shows a functional configuration of the second electronic apparatus;

FIG. 6 shows an operational flow of the first electronic apparatus and the second electronic apparatus;

FIG. 7 shows a network configuration of an apparatus setup system according to a modification example of the present embodiment; and

FIG. 8 shows a hardware configuration of a server apparatus.

### DETAILED DESCRIPTION OF THE EXEMPLARY EMBODIMENTS

Hereinafter, an embodiment of the present disclosure will be described with reference to the drawings.

### 1. APPARATUS SETUP SYSTEM

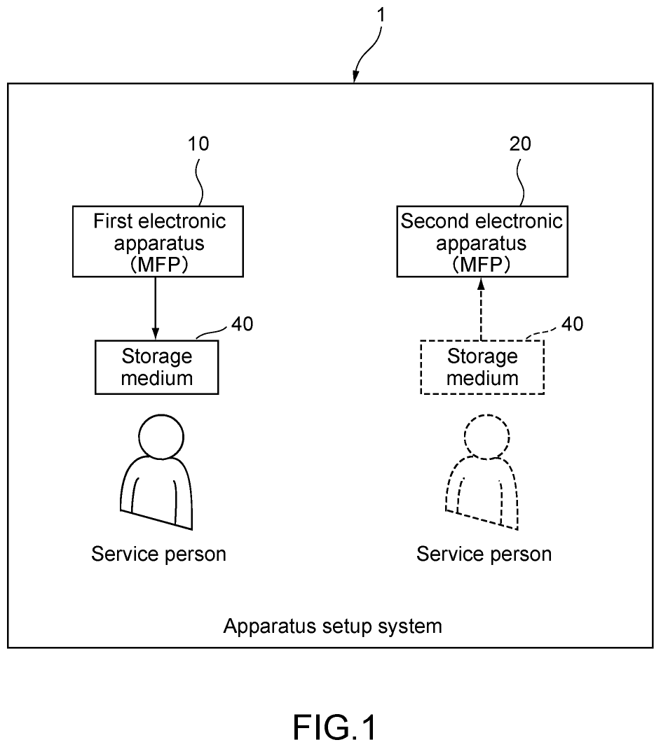

FIG. 1 shows an apparatus setup system according to an embodiment of the present disclosure.

The apparatus setup system 1 includes the first electronic apparatus 10 and the second electronic apparatus 20. Each of the first electronic apparatus 10 and the second electronic apparatus 20 is, for example, an image forming apparatus (for example, Multifunction Peripheral, MFP).

The first electronic apparatus 10 is an old apparatus to be replaced. The second electronic apparatus 20 is a new apparatus to be carried into a site of the first electronic apparatus 10.

In the first electronic apparatus 10, a certain application is installed in the upper stage of a platform including an operating system and the like.

For example, a provider (application license seller, etc.) and a user (user of the first electronic apparatus 10 and the second electronic apparatus 20) have a license agreement, in which the application is installed in only one apparatus. In the present embodiment, the user activates the application with an activation key provided by the provider. As a result, it is assured that the application is installed in only one apparatus.

Various activation key modes are conceivable. In the present embodiment, an activation key is a text generated on a basis of an electronic apparatus identifier (serial number) unique to one electronic apparatus under a license agreement and an application identifier (serial number) identifying the application.

However, it may be burdensome for a user to file an application for an issue of an activation key. It may take time to issue the activation key. A provider may sometimes not issue the activation key promptly for sudden replacement.

In the present embodiment, when an electronic apparatus is replaced, an application for an issue of an activation key is not filed. Instead, an application is provisionally activated in a new electronic apparatus by means of provisional setup. In short, the second electronic apparatus 20 is set up in a provisional setup mode. As a result, it takes a shorter time for replacement.

The package file P, which includes information necessary for the provisional setup, is transferred from the first electronic apparatus 10 to the second electronic apparatus 20. A method of transferring the package file P is not limited.

For example, in the present embodiment, a service person visits a client site of the first electronic apparatus 10, and operates the first electronic apparatus 10. The first electronic apparatus 10 outputs the package file P in the storage medium 40 such as a USB (Universal Serial Bus) memory. After that, the service person inputs the storage medium 40 in the second electronic apparatus 20 at a service center or the like. The second electronic apparatus 20 reads the storage medium 40, and inputs the package file P in the read storage medium 40 in the second electronic apparatus 20. Note that the package file P may be transferred online via a network.

### 2. HARDWARE CONFIGURATION OF ELECTRONIC APPARATUS

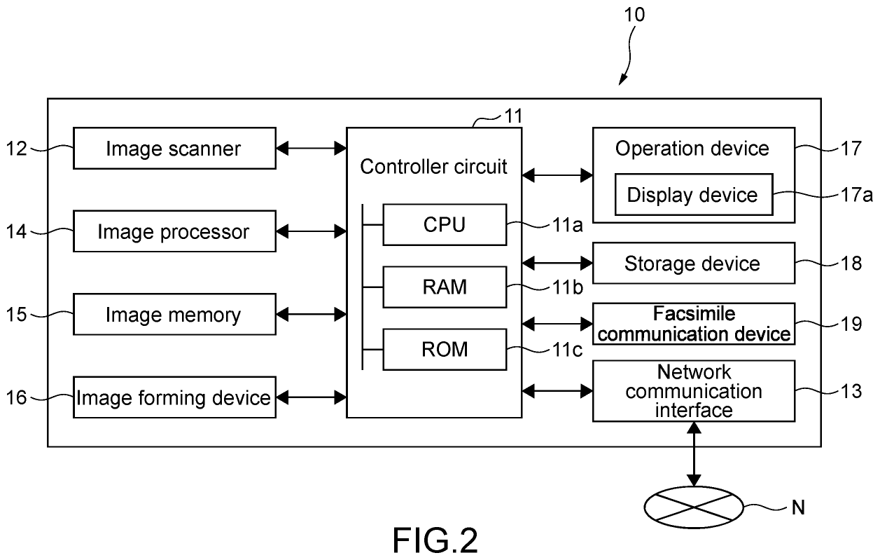

FIG. 2 shows a hardware configuration of a first electronic apparatus.

The first electronic apparatus 10 includes the controller circuit 11. The controller circuit 11 includes the CPU (Central Processing Unit) 11a, the RAM (Random Access Memory) 11b, the ROM (Read Only Memory) 11c, dedicated hardware circuits, and the like and performs overall operational control of the first electronic apparatus 10. The CPU 11a loads information processing programs stored in the ROM 11c in the RAM 11b and executes the information processing programs. The ROM 11c is a nonvolatile memory that stores programs executed by the CPU 11a, data, and the like. The ROM 11c is an example of a non-transitory computer readable recording medium.

The controller circuit 11 is connected to the image scanner 12, the image processor 14 (including GPU (Graphics Processing Unit)), the image memory 15, the image forming device 16 (printer), the operation device 17 including the display device 17a (touch panel), the large volume nonvolatile storage device 18 such as an HDD (Hard Disk Drive) or an SSD (Solid State Drive), the facsimile communication device 19, the network communication interface 13, and the like. The controller circuit 11 performs operational control of the respective devices connected thereto and sends/receives signals and data to/from those devices. The operation device 17 (touch panel) is one mode of an input module. A sound input module including a microphone may be provided as an input module.

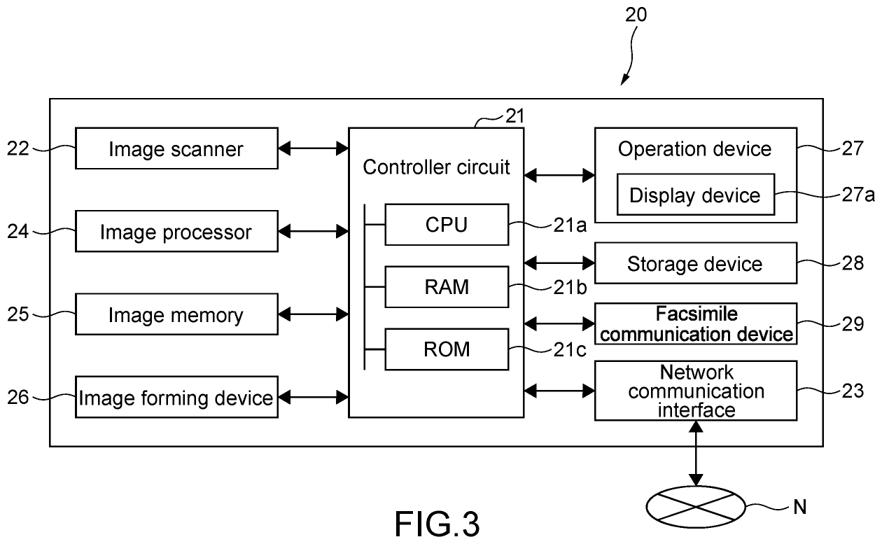

FIG. 3 shows a hardware configuration of a second electronic apparatus.

A hardware configuration of the second electronic apparatus 20 is similar to the hardware configuration of the first electronic apparatus 10. The second electronic apparatus 20 includes the controller circuit 21. The controller circuit 21 includes the CPU (Central Processing Unit) 21a, the RAM (Random Access Memory) 21b, the ROM (Read Only Memory) 21c, dedicated hardware circuits, and the like and performs overall operational control of the second electronic apparatus 20. The CPU 21a loads information processing programs stored in the ROM 21c in the RAM 21b and executes the information processing programs. The ROM 21c is a nonvolatile memory that stores programs executed by the CPU 21a, data, and the like. The ROM 21c is an example of a non-transitory computer readable recording medium.

The controller circuit 21 is connected to the image scanner 22, the image processor 24 (including GPU (Graphics Processing Unit)), the image memory 25, the image forming device 26 (printer), the operation device 27 including the display device 27a (touch panel), the large volume nonvolatile storage device 28 such as an HDD (Hard Disk Drive) or an SSD (Solid State Drive), the facsimile communication device 29, the network communication interface 23, and the like. The controller circuit 21 performs operational control of the respective devices connected thereto and sends/receives signals and data to/from those devices. The operation device 27 (touch panel) is one mode of an input module. A sound input module including a microphone may be provided as an input module.

### 3. FUNCTIONAL CONFIGURATION OF ELECTRONIC APPARATUS

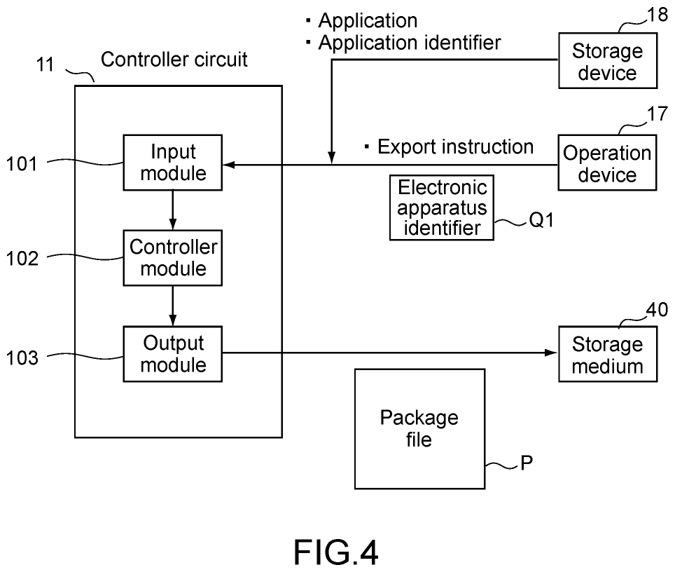

FIG. 4 shows a functional configuration of the first electronic apparatus.

In the controller circuit 11 of the first electronic apparatus 10, the CPU 11a loads an information processing program stored in the ROM 11c in the RAM 11b and executes the information processing program to operate as the input module 101, the controller module 102, and the output module 103.

The input module 101 inputs an export instruction, the electronic apparatus identifier Q1, an application, and an application identifier in the controller module 102. The electronic apparatus identifier Q1 is a value unique to the second electronic apparatus 20. The application identifier is, for example, a serial number, and includes information identifying the application.

For example, in the present embodiment, a service person inputs the export instruction by operating the operation device 17.

For example, in the present embodiment, the service person inputs the electronic apparatus identifier Q1 by operating the operation device 17. Alternatively, the input module 101 may download the electronic apparatus identifier Q1 from a server apparatus (not shown) via a network, and input the electronic apparatus identifier Q1 in the controller module 102.

For example, in the present embodiment, the controller circuit 11 reads the application and the application identifier stored in the storage device 18, and inputs the application and the application identifier in the controller module 102.

Where an export instruction is input, the controller module 102 generates the package file P on the basis of the application, the application identifier, and the electronic apparatus identifier Q1.

The output module 103 writes the package file P in the storage medium 40.

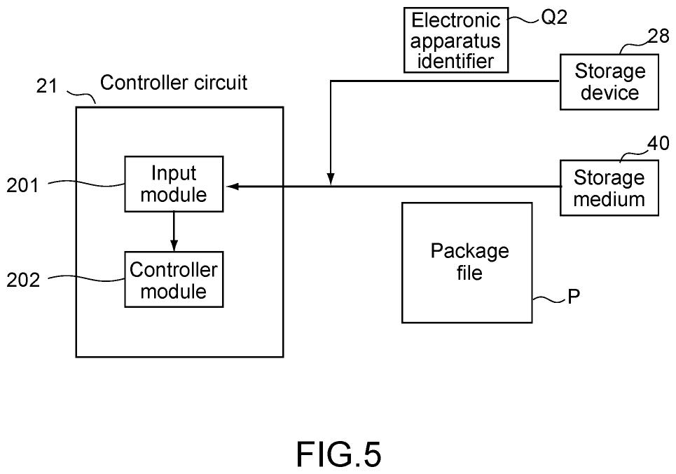

FIG. 5 shows a functional configuration of the second electronic apparatus.

In the controller circuit 21 of the second electronic apparatus 20, the CPU 21a loads an information processing program stored in the ROM 21c in the RAM 21b and executes the information processing program to operate as the input module 201 and the controller module 202.

The input module 201 inputs the electronic apparatus identifier Q2 and the package file P in the controller module 202. The electronic apparatus identifier Q2 is a value unique to the second electronic apparatus 20.

For example, in the present embodiment, the storage device 28 stores the electronic apparatus identifier Q2. The input module 201 reads the electronic apparatus identifier Q2 from the storage device 28, and inputs the electronic apparatus identifier Q2 in the controller module 202. Alternatively, the input module 201 may download the electronic apparatus identifier Q2 from a server apparatus (not shown) via a network, and input the electronic apparatus identifier Q2 in the controller module 202.

For example, in the present embodiment, the package file P is stored in the storage medium 40. The input module 201 reads the package file P from the storage medium 40, and inputs the package file P in the controller module 202.

Where the package file P is input, the controller module 202 determines whether or not the package file P matches a certain condition, decompresses the package file P, and provisionally sets up the application.

Functional configurations of the electronic apparatuses have been described above. Hereinafter, an operational flow of the electronic apparatuses will be described.

### 4. OPERATIONAL FLOW OF ELECTRONIC APPARATUSES

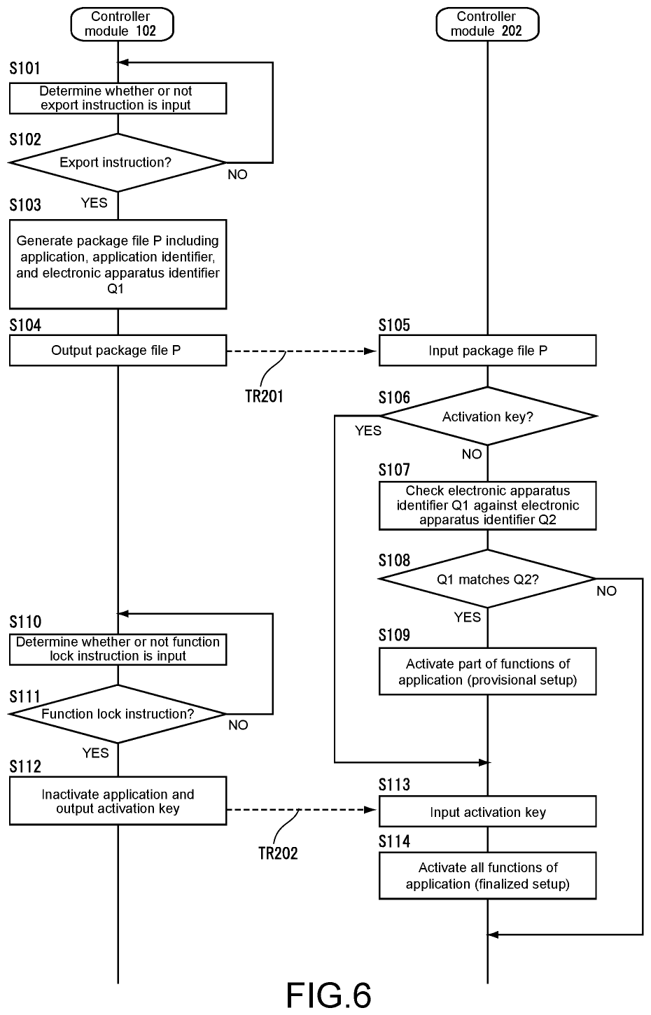

FIG. 6 shows an operational flow of the first electronic apparatus and the second electronic apparatus.

The controller module 102 of the controller circuit 11 determines whether or not an export instruction is input (Step S101). For example, where the input module 101 inputs an export instruction in the controller module 102, the controller module 102 determines that an export instruction is input (Step S102, YES). Meanwhile, where no export instruction is input in the controller module 102, the controller module 102 determines that no export instruction is input (Step S102, NO).

Where an export instruction is input, the controller module 102 generates the package file P including an application, an application identifier, and the electronic apparatus identifier Q1 (Step S103).

Subsequently, the controller module 102 controls the output module 103 to output the generated package file P to the storage medium 40 (Step S104).

Note that, for example, in the present embodiment, the input module 101 inputs the export instruction and the electronic apparatus identifier Q1 on the basis of manual input of a service person. The output module 103 outputs the package file P by writing the package file P in the storage medium 40 such as a USB memory inserted by a service person. However, this is merely an example. Note that, in this case, the service person visits a client site of the first electronic apparatus 10 and operates as described above.

The package file P is output from the first electronic apparatus 10, and is transferred to and input in the second electronic apparatus 20 (TR201). For example, the package file P is transferred via the storage medium 40 and a service person. However, this is merely an example.

Where the input module 201 inputs the package file P (Step S105), the controller module 202 of the controller circuit 21 determines whether or not the package file P includes an activation key (Step S106).

Where the package file P has no activation key (Step S106, NO), the controller module 202 checks the electronic apparatus identifier Q1 included in the package file P against the electronic apparatus identifier Q2 of the apparatus itself for check stored in the storage device 28 of the apparatus itself (the second electronic apparatus 20) (Step S107).

Subsequently, the controller module 202 determines whether or not the electronic apparatus identifier Q1 matches the electronic apparatus identifier Q2 (Step S108). Where the electronic apparatus identifier Q1 matches the electronic apparatus identifier Q2 (Step S108, YES), the controller module 202 installs the application such that a part of functions of the application, which is identified by the application identifier included in the package file P, is activated (Step S109). The install for activating a part of functions will be referred to as provisional setup.

Details of the part of functions of the application activated by the controller module 202 are not limited. For example, in the present embodiment, in Step S109, the controller module 202 activates a function of changing setting of the application or newly configuring setting of the application.

The controller module 202 restricts a part of functions of the provisionally-setup application. Restricted functions are not limited. For example, in the present embodiment, the application is controlled such that the application is incapable of executing print jobs and the like. In addition, for example, the controller module 202 may control the application such that the application is incapable of using an API (Application-Program Interface) provided by the platform. Alternatively, the application may be controlled such that functions, which require authentication to use the second electronic apparatus 20, are restricted. In this case, for example, an authenticated user is limited to a service person, and a user of the second electronic apparatus 20 may thereby be limited.

To activate an application or activation of an application at least means to install an application in an electronic apparatus and to establish a status where various settings of the application are acceptable, i.e., for example, a status where to display an application setting window is allowed. Then, according to the present embodiment, the second electronic apparatus 20 is capable of activating an application without an activation key.

There are levels of activation of an application. Then the processing from Step S101 to Step S109 of the apparatus setup system 1 realizes minimum-level activation. In the present embodiment, the following processing is further executed. As a result, full activation or finalized setup is realized, in which access to all the functions of the application is allowed.

Note that, for example, in the present embodiment, a service person inserts the storage medium 40 such as a USB memory in the second electronic apparatus 20 at a service center or the like to input the package file P. However, this is merely an example.

Meanwhile, the controller module 102 of the controller circuit 11 determines whether or not a function lock instruction is input (Step S110). For example, where the input module 101 inputs a function lock instruction in the controller module 102, the controller module 102 determines that a function lock instruction is input (Step S111, YES). Meanwhile, where a function lock instruction is not input in the controller module 102, the controller module 102 determines that no function lock instruction is input (Step S111, NO).

Where a function lock instruction is input, the controller module 102 locks functions of the application installed in the first electronic apparatus 10 and inactivates the functions. In addition, the controller module 102 controls the output module 103 to output an activation key, with which the application is activated in one electronic apparatus (Step S112).

An output mode of the activation key is not limited. In the present embodiment, for example, the output module 103 displays texts showing the activation key on the display device 17a.

The activation key is output from the first electronic apparatus 10, and is transferred to and input in the second electronic apparatus 20 (TR202). For example, the activation key is transferred via the storage medium 40 and a service person. However, this is merely an example.

Where the input module 201 inputs the activation key (Step S113), the controller module 202 of the controller circuit 21 activates all the functions of the application (Step S114).

Note that, for example, in the present embodiment, a service person visits the client site of the first electronic apparatus 10, locks the functions of the first electronic apparatus 10, removes the first electronic apparatus 10, carries the second electronic apparatus 20 into the client site, and executes finalized setup of the second electronic apparatus 20.

According to the present embodiment described above, the first electronic apparatus 10 includes the controller module 102. The controller module 102 generates the package file P including the electronic apparatus identifier Q1, which may be the same as the electronic apparatus identifier Q2 of the second electronic apparatus 20. The second electronic apparatus 20 includes the controller module 202 in which the package file P is input. The controller module 202 checks the electronic apparatus identifier Q1 included in the package file P against the electronic apparatus identifier Q2. Where the electronic apparatus identifier Q1 matches the electronic apparatus identifier Q2, the controller module 202 activates a part of functions of the application identified by the application identifier included in the package file P. As a result, the application is provisionally activated without an activation key, and an interface for various setting operations is thereby activated. As a result, a downtime is reduced.

### 5. MODIFICATION EXAMPLES

In the present embodiment, a data structure or a format of information included in the package file P is not limited. However, the controller module 102 of the first electronic apparatus 10 may encode the package file P to avoid changes of the file. Specifically, the controller module 102 encodes the electronic apparatus identifier Q1 of the second electronic apparatus 20 to avoid changes of the electronic apparatus identifier Q1. In this case, it is possible to prevent activation of an application in multiple electronic apparatuses by using the package file P output from one electronic apparatus (in this case, the first electronic apparatus 10).

In the present embodiment, when the input module 201 inputs the package file P in the controller module 202, the controller module 202 confirms whether or not the package file P includes an activation key (Step S106). After that, the controller module 202 checks the electronic apparatus identifier Q1 against the electronic apparatus identifier Q2 (Step S107). However, the order may be inversed. In this case, the controller module 202 firstly checks the electronic apparatus identifier Q1 against the electronic apparatus identifier Q2. If the electronic apparatus identifier Q1 matches the electronic apparatus identifier Q2, the controller module 202 determines that an activation key is not required. If the electronic apparatus identifier Q1 does not match the electronic apparatus identifier Q2, the controller module 202 determines that an activation key is required.

In the present embodiment, when an activation key is input, the controller module 202 of the second electronic apparatus 20 activates all the functions of the application. However, the controller module 202 may activate not all the functions. Instead, the number of functions activated with an activation key may only be relatively larger than number of functions activated (provisionally setup) without an activation key. The number of activated functions in the provisional setup status is relatively smaller than the number of activated functions in the finalized setup status. In other words, functions are restricted in the provisional setup status. The reason is as follows. In the first electronic apparatus 10, the application is still activated in the finalized setup status until functions are locked.

In an example of the present embodiment, a service person transfers the package file P (TR201) and transfers an activation key (TR202). However, an electronic apparatus may transfer them to another electronic apparatus via a network in the following mode.

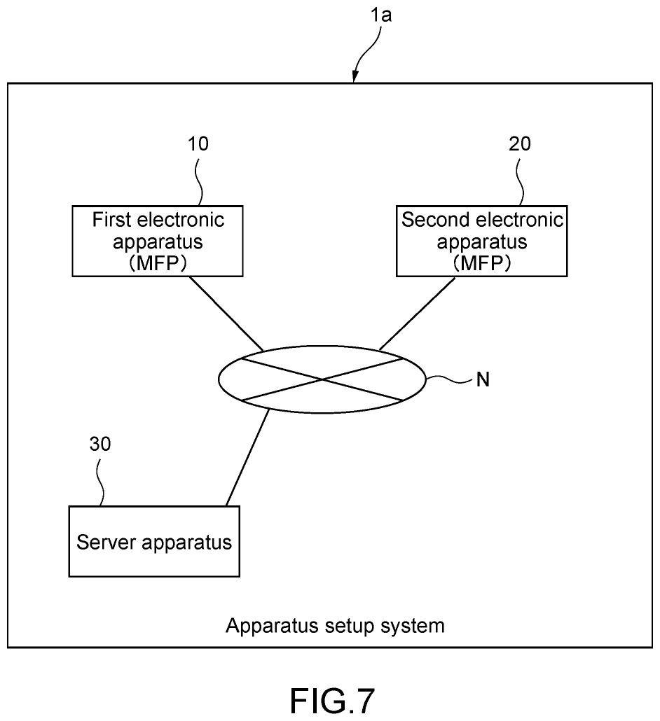

FIG. 7 shows a network configuration of an apparatus setup system according to a modification example of the present embodiment.

In the present modification example, the apparatus setup system 1a includes the first electronic apparatus 10, the second electronic apparatus 20, and the server apparatus 30. The first electronic apparatus 10, the second electronic apparatus 20, and the server apparatus 30 are communicably connected to each other via network N.

The configuration of each of the first electronic apparatus 10 and the second electronic apparatus 20 is the same as that of the embodiment, and will not be described.

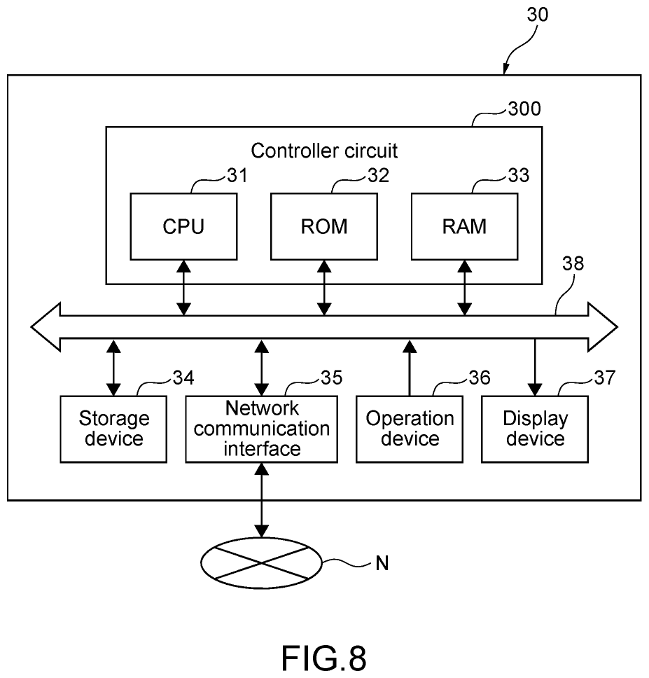

FIG. 8 shows a hardware configuration of a server apparatus.

The server apparatus 30 includes the CPU 31, the ROM 32, the RAM 33, the storage device 34, which is a large-volume nonvolatile memory such as an HDD or an SSD, the network communication interface 35, the operation device 36, and the display device 37, and the bus 38 connecting them to each other.

The controller circuit 300 includes the CPU 31, the ROM 32, and the RAM 33. The CPU 31 loads information processing programs stored in the ROM 32 in the RAM 33 and executes the information processing programs. The ROM 32 stores programs executed by the CPU 31, data, and the like nonvolatile. The ROM 32 is an example of a non-transitory computer readable recording medium.

In the present modification example, the server apparatus 30 transfers the package file P and the activation key of FIG. 6 by using the network configuration and the hardware configuration. Further, the server apparatus 30 inputs the export instruction and the package file P.

Specifically, the controller module 102 of the first electronic apparatus 10 controls the output module 103 to output the package file P and the activation key to the server apparatus 30. Further, the controller module 102 controls the input module 101 to input, to the controller module 102, the export instruction and the function lock instruction input in the first electronic apparatus 10 from the server apparatus 30.

The controller module 202 of the second electronic apparatus 20 controls the input module 201 to input, in the controller module 202, the package file P and the activation key input in the second electronic apparatus 20 from the server apparatus 30.

The controller circuit 300 of the server apparatus 30 receives the package file P from the first electronic apparatus 10 via network communication interface 35. Then the controller circuit 300 temporarily stores the package file P in the storage device 34, and controls the network communication interface 35 to send the package file P to the second electronic apparatus 20.

According to the aforementioned modification example, a downtime may be reduced independent of work of a service person.

Any configurations disclosed in the present embodiment may be embodied in combination.

### 6. CONCLUSION

Typically, it is necessary to transfer a license and set up a new electronic apparatus at a site of an electronic apparatus. It takes time to transfer a license and set up a new electronic apparatus, which is a downtime. In other words, a user of the electronic apparatus is incapable of using the electronic apparatus during the downtime. Setup includes obtaining an activation key and application of the activation key in an electronic apparatus.

When an electronic apparatus is replaced suddenly, it may take long time to apply an obtained activation key after an application to issue the activation key is filed. In this case, according to the aforementioned method of transferring a license and setting up a new electronic apparatus at a site of an electronic apparatus, the whole schedule of replacement work may be longer or the work schedule may not be prepared, which is troublesome.

(1) To the contrary, according to the present embodiment, the first electronic apparatus exports a package file for transferring an application including the electronic apparatus identifier of the second electronic apparatus. When the second electronic apparatus imports the package file, the second electronic apparatus checks the electronic apparatus identifier included in the package file against the stored electronic apparatus identifier. Only if the electronic apparatus identifier included in the package file matches the stored electronic apparatus identifier after the check, the application is activated. According to the present embodiment, it is not necessary to issue an activation key or the like, which is used to activate the application by the second electronic apparatus for transferring a license of the application, to the second electronic apparatus. As a result, according to the present embodiment, it is possible to reduce a downtime without an activation key when an electronic apparatus is replaced, where the electronic apparatus has an application that requires an activation key for activation.

(2) According to the present embodiment, where the package file for transferring an application fails to include an activation key to activate the application in the second electronic apparatus, the second electronic apparatus checks the electronic apparatus identifier included in the package file against the stored electronic apparatus identifier, and activates the application. As a result, according to the present embodiment, even if an activation key is not issued to the second electronic apparatus, it is possible to reduce a downtime when an electronic apparatus is replaced, where the electronic apparatus has an application that requires transfer of a license.

(3) According to the present embodiment, the number of functions activated with an activation key is larger than the number of functions activated without an activation key. As a result, according to the present embodiment, functions are restricted when the application is activated without an activation key. As a result, a user of the second electronic apparatus is advised to have an activation key without losing an application provider's right unreasonably.

(4) According to the present embodiment, an application installed in the first electronic apparatus, from which the application is transferred, is inactivated. The second electronic apparatus outputs an activated activation key. As a result, according to the present embodiment, a downtime is reduced. Further, according to the present embodiment, an application provider does not need to issue a new activation key. As a result, a burden of the issue process may be reduced, which is beneficial. It is possible to reduce a situation where the application provider urgently supports a sudden application, which is beneficial.

(5) According to the present embodiment, a server apparatus inputs an export instruction in the first electronic apparatus, and inputs the package file in the second electronic apparatus. As a result, the input and output are executed independent of work of a service person or the like.

It should be understood by those skilled in the art that various modifications, combinations, sub-combinations and alterations may occur depending on design requirements and other factors insofar as they are within the scope of the appended claims or the equivalents thereof

What is claimed is:

1. An apparatus setup system, comprising:
a first electronic apparatus; and
a second electronic apparatus,
the first electronic apparatus including
a first storage device that stores an application and an application identifier unique to the application, and
a first controller module configured to generate a package file where an export instruction is input, the export instruction instructing to export an application, the package file at least including the application identifier and an electronic apparatus identifier of one different electronic apparatus,
the second electronic apparatus including
a second storage device that stores an electronic apparatus identifier identifying the second electronic apparatus from a different electronic apparatus, and
a second controller module configured to
where the package file is input, check the electronic apparatus identifier included in the input package file against the electronic apparatus identifier stored in the second storage device, and
where it is determined that the electronic apparatus identifier included in the input package file matches the electronic apparatus identifier stored in the second storage device, activate the application identified by the application identifier included in the package file.

2. The apparatus setup system according to claim 1, wherein
the second controller module is configured to
where it is determined that the package file fails to include an activation key for activating the application and it is determined that the electronic apparatus identifier included in the input package file matches the electronic apparatus identifier stored in the second storage device, activate the application identified by the application identifier included in the package file.

3. The apparatus setup system according to claim 2, wherein
the second controller module is configured to activate the application, a number of functions of the application activated by using the activation key being larger than a number of functions of the application activated without the activation key.

4. The apparatus setup system according to claim 2, wherein
the first controller module is configured to
inactivate the application and output the activation key where a function lock instruction is input in the first electronic apparatus, the function lock instruction instructing to lock a function of the application.

5. The apparatus setup system according to claim 1, further comprising:
a server apparatus including a remote input module configured to input the export instruction in the first electronic apparatus via a communication network, and input the package file in the second electronic apparatus via communication network.

6. An apparatus setup method of setting up a second electronic apparatus executable by an apparatus setup system, the apparatus setup system including a first electronic apparatus and the second electronic apparatus, the first electronic apparatus including a first input module and a first controller module, the second electronic apparatus including a second input module and a second controller module, the apparatus setup method comprising:
inputting, by the first input module, an export instruction in the first controller module, the export instruction instructing to export an application;
outputting, by the first controller module, a package file where the export instruction is input, the package file at least including an electronic apparatus identifier of the second electronic apparatus and an application identifier unique to the application;
inputting, by the second input module, the package file in the second controller module;
where the package file is input, checking, by the second controller module, the electronic apparatus identifier of the second electronic apparatus included in the input package file against an electronic apparatus identifier stored in the second electronic apparatus; and
where it is determined that the electronic apparatus identifier of the second electronic apparatus included in the input package file matches the electronic apparatus identifier stored in the second electronic apparatus, activating, by the second controller module, the application identified by the application identifier included in the package file.

7. An electronic apparatus, comprising:
a storage device;
an input module; and
a controller module,
the storage device storing
an application,
an application identifier unique to the application, and
an electronic apparatus identifier identifying the electronic apparatus from a different electronic apparatus,
the input module being configured to input an export instruction and a package file in the electronic apparatus, the export instruction instructing to export the application, the package file being used to import the application,
the controller module being configured to
generate the package file where the export instruction is input, the package file at least including the application identifier and the electronic apparatus identifier of one different electronic apparatus,
where the package file is input, check the electronic apparatus identifier included in the input package file against the electronic apparatus identifier stored in the storage device, and
where it is determined that the electronic apparatus identifier included in the input package file matches the electronic apparatus identifier stored in the storage device, activate the application identified by the application identifier included in the package file.
